(19) United States
(12) Patent Application Publication
(10) Pub. No.: US 2026/0268937 A1
(43) Pub. Date: Sep. 10, 2026

(54) MAGNETIC DISK DEVICE AND METHOD OF CONTROLLING THE SAME

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Yusuke Nakayama, Ota Tokyo (JP); Osamu Yoshida, Kawasaki Kanagawa (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 19/286,862

(22) Filed: Jul. 31, 2025

(30) Foreign Application Priority Data
Mar. 5, 2025 (JP) 2025-034584

(51) Int. Cl. G11B 20/12

(52) U.S. Cl. CPC G11B 20/1217; G11B 2020/1292

(57) ABSTRACT

According to one embodiment, a magnetic disk device includes a circular magnetic disk on which a plurality of tracks for recording data are formed in a radial direction, and a magnetic head which can move in a radial direction of the magnetic disk and perform data write and read on each of the tracks of the magnetic disk. The tracks include pairs of two tracks adjacent to each other without a gap, each two being as a pair of tracks, and there are gaps respectively between these pairs of tracks.

### CROSS-REFERENCE TO RELATED APPLICATIONS

This application is based upon and claims the benefit of priority from Japanese Patent Application No. 2025-034584, filed Mar. 5, 2025, the entire contents of which are incorporated herein by reference.

### FIELD

Embodiments described herein relate generally to a magnetic disk device comprising a magnetic disk and a magnetic head, and a method of controlling the same.

### BACKGROUND

In a magnetic disk device comprising a magnetic disk and a magnetic head which write/read data to/from the magnetic disk, a plurality of tracks for recording data are formed to be arranged along a radial direction of the magnetic disk with gaps respectively therebetween.

Since there are gaps each between each respective adjacent pair of tracks on the magnetic disk, there is naturally a limitation on the number of tracks that can be formed even so designed. This limitation affects the recording capacity of the magnetic disk.

### BRIEF DESCRIPTION OF THE DRAWINGS

FIG. 1 is a block diagram showing a configuration of one embodiment.

FIG. 2 is a diagram showing the configuration of a magnetic head together with tracks on a magnetic disk in one embodiment.

FIG. 3 is a diagram showing a magnetic disk and each track on the magnetic disk in one embodiment.

FIG. 4 is a diagram showing an example of a pair track in one embodiment.

FIG. 5 is a diagram showing another example of the pair track in the embodiment.

FIG. 6 is a flowchart showing control of a controller in one embodiment.

FIG. 7 is a diagram showing an example of data written to a pair track in one embodiment.

FIG. 8 is a diagram showing another example of data written to the pair track in the embodiment.

FIG. 9 is a diagram showing a configuration in which three tracks are in contact with each other, as a reference.

### DETAILED DESCRIPTION

In general, according to one embodiment, a magnetic disk device includes a circular magnetic disk on which a plurality of tracks for recording data are formed in a radial direction; and a magnetic head which can move in a radial direction of the magnetic disk and perform data write and read on each of the tracks of the magnetic disk. The tracks include pairs of two tracks adjacent to each other without a gap, each two being as a pair of tracks, and there are gaps respectively between these pairs of tracks.

One embodiment will be described hereinafter with reference to the accompanying drawings.

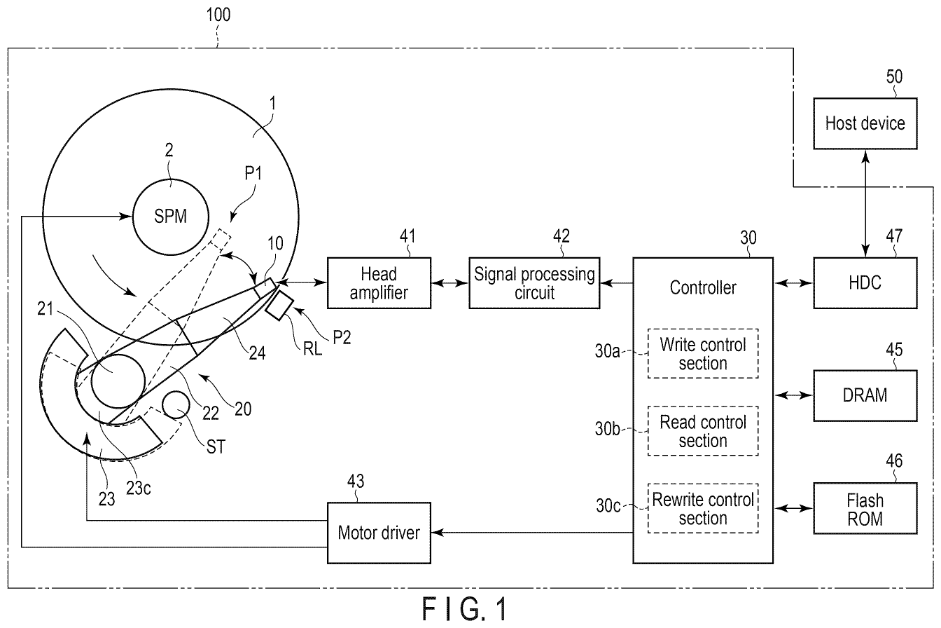

As shown in FIG. 1, a magnetic disk device 100 includes a circular magnetic disk 1, which is a recording medium, a spindle motor (SPM) 2 that rotates the magnetic disk 1, and a magnetic head 10 that writes and reads data to and from the magnetic disk 1.

The magnetic head 10 is supported to be rotatable by an actuator 20. The actuator 20 includes a rotation shaft 21, an arm 22 attached to the rotation shaft 21, a voice coil motor 23 that provides rotational force to the arm 22, and a suspension member 24 attached to a tip end portion of the arm 22. On the tip of the suspension member 24, the magnetic head 10 is mounted. The voice coil motor 23 includes a coil 23c, a magnet, and a yoke, and when a drive current flows through the coil 23c, the arm 22 is pivoted.

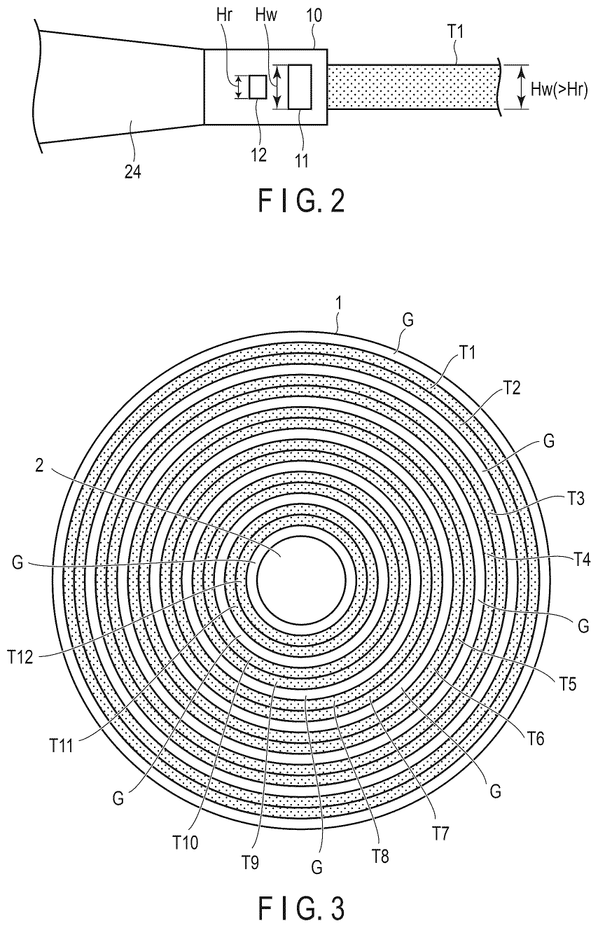

The magnetic head 10 includes a write element 11 for writing data, which write magnetic data to the magnetic disk 1 and a read element 12 for reading data, which read magnetic data from the magnetic disk 1, as shown in FIG. 2. The write element 11 has a width Hw, which is the same as a width Hw of each of the tracks T1 to T12, which will be described later. The read element 12 has a width Hw that is less than the width Hw of each of the tracks T1 to T12, which will be described later.

The magnetic head 10 moves (seeks) along the radial direction of the magnetic disk 1 between a first position P1 indicated by the dashed line and a second position P2 on an outer circumferential side, indicated by the solid line as the actuator 20 pivots.

In the vicinity of the actuator 20, a stopper ST and a ramp mechanism RL are disposed. The stopper ST limits the movement position of the magnetic head 10 in an inner circumferential side of the magnetic disk 1. The ramp mechanism RL retracts the magnetic head 10 from above the magnetic disk 1 when the spindle motor 2 is stopped.

The magnetic disk 1 includes a recording surface facing the magnetic head 10, as shown in FIG. 3. On this recording surface, a plurality of tracks T1 to T12 for data writing are formed along a radial direction.

The tracks T1 to T12 include pairs of tracks that are adjacent to each other without a gap G. There is a gap G between each respective pair of tracks.

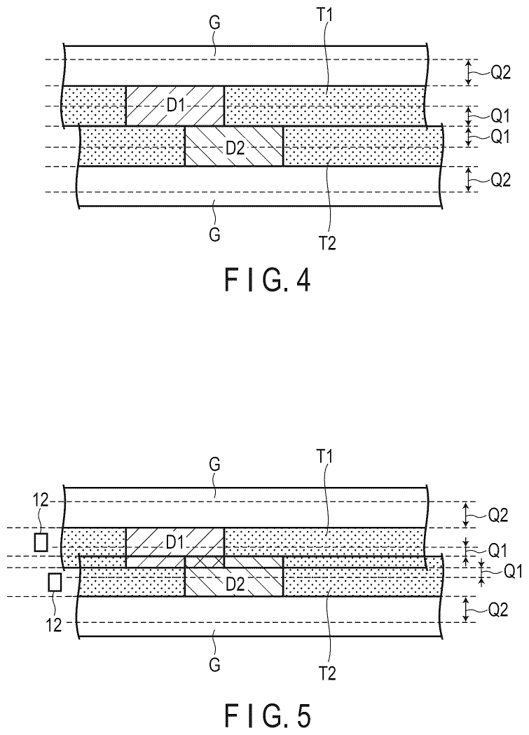

Specifically, as shown in FIG. 4, the side edges of each of the adjacent tracks T1 and T2 that are in contact with each other without a gap G form a first pair of tracks. To the track T1, data D1 is written, and data D2 is written to the track T2. Similarly, the side edges of each of the adjacent tracks T3 and T4 that are in contact with each other without a gap G form a second pair of tracks. In this manner, adjacent tracks T5 and T6, whose side edges are in contact with each other without a gap G form a third pair of tracks. Further, adjacent tracks T7 and T8, whose side edges are in contact with each other without a gap G form a fourth pair of tracks. Furthermore, adjacent tracks T9 and T10, whose side edges are in contact with each other without a gap G form a fifth pair of tracks. Furthermore, adjacent tracks T11 and T12, whose side edges are in contact with each other without a gap G form a sixth pair of tracks.

Between the track T2 of the first pair and the tracks T3 of the second pair, there is a gap G that is approximately the same as a width Hw of each track T. Between the track T4 of the second pair and the track T5 of the third pair, there is a gap G that is approximately the same as the width Hw of each track T. Between the track T6 of the third pair and the track T7 of the fourth pair, there is a gap G that is approximately the same as the width Hw of each track T. Between the track T8 of the fourth pair and the track T9 of the fifth pair, there is a gap G that is approximately the same as the width Hw of each track T. Between the track T10 of the fifth pair of and the track T11 of the sixth pair, there is a gap G that is approximately the same as the width Hw of each track T. Between the track T12 of the sixth pair and the rotation axis of the spindle motor 2, there is a gap G that is approximately the same as the width Hw of each track T. The gaps G are originally areas where data is not written.

As described above, every two tracks T out of the tracks T1 to T12 are configured to form a pair track in which tracks of each pair are adjacent to each other without a gap G therebetween, and there is a gap G between each pair of tracks. With this configuration, it is possible to increase the number of tracks T as many as possible within a limited area on the magnetic disk 1. Since the number of tracks T can be increased within a limited area on the magnetic disk 1, the storage capacity of the magnetic disk 1 can be increased.

Further, the density of the tracks T on the magnetic disk 1 increases, and therefore the movement distance (seek distance) of the magnetic head 10 during seek operations for the magnetic head 10 is reduced. Therefore, the seek performance of the magnetic head 10 can be improved.

Note that the configuration is not limited to that shown in FIG. 4. For example, as shown in FIG. 5, a part of one track T1 and a part of the other track T2 in the first pair of tracks may be configured to overlap each other in the radial direction of the magnetic disk 1. With this configuration, the number of tracks T on the magnetic disk 1 can be increased further than that in the example shown in FIG. 4. Since the number of tracks T on the magnetic disk 1 is further increased, the recording capacity of the magnetic disk 1 is further increased.

Even with the configuration where a part of the track T1 overlaps with a part of the track T2, the width of the read element 12 is less than the width Hw of the track T1, and therefore the data D1 written to the track T1 can be read accurately without being affected by the data D2 written on the track T2. Since the width of the read element 12 is less than the width Hw of the track T2, the data D2 written to the track T2 can be accurately read without being affected by the data D1 written on the track T1. That is, the overwrite (writing over) and individual read of the data D1 and D2 with respect to the tracks T1 and T2 can be performed regardless of the writing order and reading order, that is, the so-called random read/write operations.

Similarly, in the second pair of tracks, a part of one track T3 and a part of the other track T4 overlap each other in the radial direction of the magnetic disk 1. Since the width of the read element 12 is less than the width Hw of the track T3, the data D3 written on the track T3 can be read accurately without being affected by the data D4 written on the track T4. Since the width of the read element 12 is less than the width Hw of the track T4, the data D4 written on the track T4 can be read accurately without being affected by the data D3 written on the track T3.

In the third pair of tracks, a part of one track T5 and a part of the other track T6 overlap each other in the radial direction of the magnetic disk 1. Since the width of the read element 12 is less than the width Hw of the track T5, the data D5 written on the track T5 can be accurately read without being affected by the data D6 written on the track T6. Since the width of the read element 12 is less than the width Hw of track T6, the data D6 written on the track T6 can be accurately read without being affected by the data D5 written on the track T5.

In the fourth pair of tracks, a part of one track T7 and a part of the other track T8 overlap each other in the radial direction of the magnetic disk 1. Since the width of the read element 12 is less than the width Hw of the track T7, the data D7 written on the track T7 can be accurately read without being affected by the data D8 written on the track T8. Since the width of the read element 12 is less than the width Hw of the track T8, the data D8 written on the track T8 can be read accurately without being affected by the data D7 written on the track T7.

In the fifth pair of tracks, a part of one track T9 and a part of the other track T10 overlap each other in the radial direction of the magnetic disk 1. Since the width of the read element 12 is less than the width Hw of the track T9, the data D9 written on the track T9 can be accurately read without being affected by the data D10 written on the track T10. Since the width of the read element 12 is less than the width Hw of the track T10, the data D10 written on the track T10 can be accurately read without being affected by the data D9 written on the track T9.

In the sixth pair of tracks, a part of one track T11 and a part of the other track T12 overlap each other in the radial direction of the magnetic disk 1. Since the width of the read element 12 is less than the width Hw of the track T11, the data D11 written on the track T11 can be accurately read without being affected by the data D12 written on the track T12. Since the width of the read element 12 is less than the width Hw of the track T12, the data D12 written on the track T12 can be read accurately without being affected by the data D11 written on the track T11.

The magnetic disk device 100, as shown in FIG. 1, includes a controller 30 that serves as the control center, a head amplifier 41 that drives each of magnetic heads 10, a signal processing circuit 42 provided in the connection between the head amplifiers 41 and the controller 30, a motor driver 43 that drives the spindle motor 2 and the voice coil motor 23 in response to instructions from the controller 30, a DRAM 45, which is a memory that stores programs and other data necessary for controlling the controller 30, a flash ROM 46 that stores various data necessary for controlling the controller 30, and a hard disk controller (HDC) 47 that is provided in the connection between the controller 30 and an external host device 50.

The head amplifier 41 amplifies the write signals of the data from the signal processing circuit 42 to each of the magnetic heads 10 and amplifies the read signals of the data from each of the magnetic heads 10. The signal processing circuit 42 appropriately processes the write signals from the controller 30 to the magnetic heads 10 and supplies these signals to the head amplifier 41, and appropriately processes the read signals amplified by the head amplifier 41 and supplies these signals to the controller 30.

The controller 30 controls the rotation of the magnetic disk 1, the movement (seek) of the magnetic heads 10, and data write and read by the magnetic heads 10, and it includes a write control section 30a that controls data write to the tracks T1 to T12 of the magnetic disk 1, a read control section 30b that controls data read from the tracks T1 to T12 of the magnetic disk 1, and a rewrite control section 30c that controls data rewrite to the tracks T1 to T12 of the magnetic disk 1.

The read control section 30b has the main function of reading the data written on the tracks T1 to T12 by the magnetic head 10 each time data is written to the tracks T1 to T12, and determining the state in which the read data is written to each of the areas of the tracks T1 to T12.

Specifically, the read control section 30b determines whether or not the data written to one of each pair of tracks overran (offset) by a distance equal to or greater than a second threshold value (which may as well be referred to as a second tolerance value) Q2 toward the adjacent gap G from that track (that is, whether it is off-track).

Further, the read control section 30b determines whether or not the data written to one of the pair of tracks overran (or whether it is off-track) towards the other track side of the same pair of tracks by a distance equal to or greater than a first threshold (which may as well be referred to as a first tolerance value) Q1. Note here that the first threshold value Q1 is less than the second threshold value Q2.

The rewrite control section 30c, based on the result of determination made by the read control section 30b, determines that the data written to that one of the pair of tracks is not reliably written when the data written to that one of the pair of tracks overran by the second threshold value Q2 or more from that one of the tracks toward the adjacent gap G side, and then rewrites the data written to that one track to the same one track.

Furthermore, based on the result of the determination made by the read control section 30b, the rewrite control section 30c determines, when the data written to one of the pair of tracks overran by the first threshold value Q1 (<Q2) or more from that one track to the other track side of the same pair of tracks, that the data written to that one track is not written reliably, and also determines that there is a possibility of loss of the data written to the other track (referred to as the original data). Then, the data written on that one track is rewritten to the same one track, and the original data written on the other track is rewritten to the same other track to protect the data from being lost.

Then, the rewrite control section 30c changes the first threshold value Q1 by a predetermined value ΔQ in a reduction direction to ensure that the rewritten data is reliably protected upon rewriting of data in this pair of tracks.

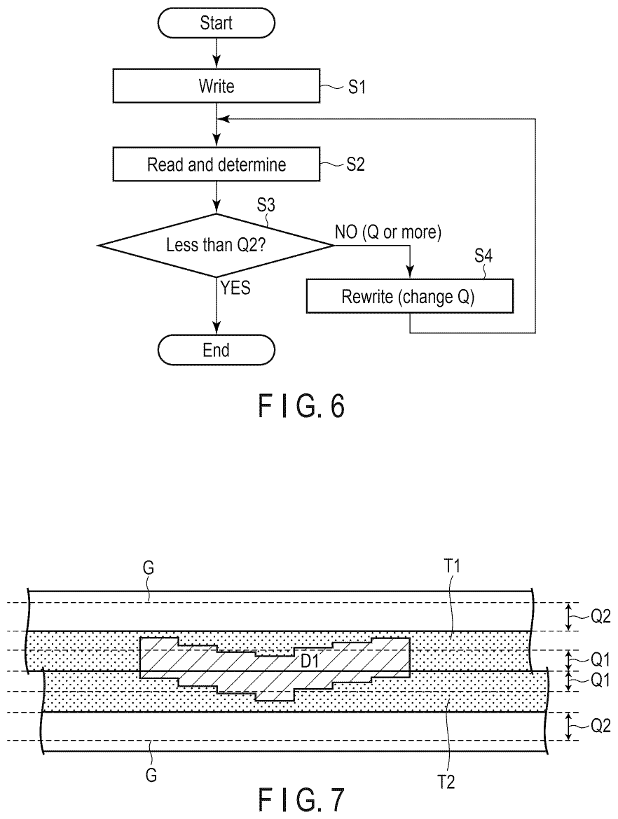

Next, the control executed by the controller 30 will be explained with reference to the flowchart in FIG. 6.

The controller 30, while controlling the rotation of the magnetic disk 1 and the movement (seek) of the magnetic head 10, write data to a predetermined track T of the magnetic disk 1 by the respective magnetic head 10 (S1).

Subsequently, the controller 30 reads the written data described above by the magnetic head 10 and determines the state in which the data is written in each of the areas of the tracks T1 to T12 (S2).

Of the first to sixth pairs of tracks, write and read of data to and from the tracks T1 and T2 of the first pair of tracks, will be described as a representative example.

The controller 30 determines whether or not the data written to the track T1 overran the second threshold value Q2 or more in the direction toward the adjacent gap G side from the track T1 (whether it is off-track). Further, the controller 30 determines whether or not the data written to the track T1 overran by the first threshold value Q1 (<Q2) or more from the track T1 toward the track T2 side (whether it is off-track).

When the data D1 written to the track T1 has not overrun by the second threshold value Q2 or more toward the adjacent gap G side from the track T1 (YES in S3), and also the data D1 written to the track T1 has not overrun by the first threshold value Q1 (<Q2) or more toward the track T2 from the track T1 (YES in S3), the controller 30 determines that the data D1 is reliably written to the track T1 and returns to the processing of step S1.

Note here, when the data D1 written to the track T1 has overrun by the second threshold value Q2 or more toward the adjacent gap G side from the track T1 due to vibrations or the like impacting on the magnetic disk 1 or the magnetic head 10 (NO in S3), the controller 30 determines that the data D1 has been written off-track unnecessarily toward the gap G side and rewrites the same data D1 to the same track T1 (S4). By this rewrite, the data D1 can be reliably recorded on the track T1 without being affected by vibrations or the like applied to the magnetic disk 1 or the magnetic head 10.

### Example Shown in FIG. 7

As shown in FIG. 7, when the data D1 written to the track T1 has overrun by a distance of the first threshold value Q1 (<Q2) or more toward the track T2 side from the track T1 due to vibrations or the like applied to the magnetic disk 1 or the magnetic head 10 (NO in S3), the controller 30 determines that the data D1 has been written off-track unnecessarily to the track T2 side and rewrites the same data D1 to the same track T1 (S4). By this rewrite, the data D1 can be reliably recorded on the track T1 without being affected by vibrations or the like applied to the magnetic disk 1 or the magnetic head 10.

In this case, when there is any original data originally written on the track T2 on the side where the data D1 was written with an overrun, the original data is rewritten to the same track T2 as well (S4). With this operation, the original data originally written on the track T2 can be protected from being lost.

The first threshold value (first tolerance value) Q1 for data off-track between the tracks T1 and T2 in pair is less than the second threshold value (second tolerance value) Q2 for data off-track toward the gap G side from the tracks T1 and T2. With this configuration, the reliability of data write and the safety of written data on the tracks T1 and T2 which make a pair can be enhanced.

Further, upon the above-described rewriting of the original data originally written on the track T2 (S4), the controller 30 changes the first threshold value Q1 in the reduction direction by a predetermined value ΔQ in order to reliably protect the rewritten data D1 on the track T1 with even higher safety from the offsetting of the original data rewritten to the track T2.

When the original data originally written on the track T2 is rewritten to the track T2, and further the rewritten original data has overrun by a distance of the new first threshold value “Q1-ΔQ” or more from the track T2 to the track T1 side (NO in S3), the controller 30 determines that the original data is written off-track unnecessarily towards the track T1 side, and then rewrites the same original data to the track T2, and further rewrites the rewritten data D1 already on the track T1 to the track T1 (S4).

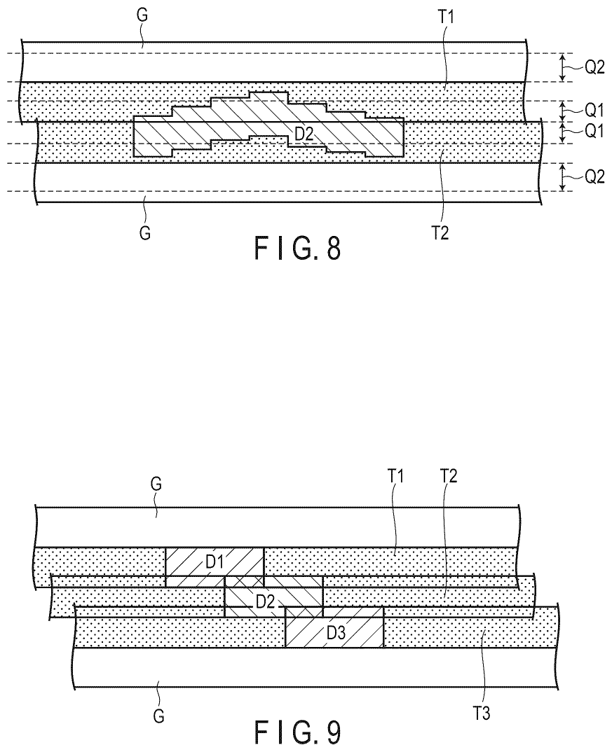

### Example Shown in FIG. 8

As shown in FIG. 8, when the data D2 written to the track T2 has overrun by a distance of the first threshold value Q1 (<Q2) or more toward the track T1 side from the track T2 due to vibrations or the like applied to the magnetic disk 1 or the magnetic head 10 (NO in S3), the controller 30 determines that the data D2 has been written off-track unnecessarily to the track T1 side and rewrites the same data D2 to the track T2 (S4). By this rewrite, the data D2 can be reliably recorded on the track T2 without being affected by vibrations or the like applied to the magnetic disk 1 or the magnetic head 10.

In this case, when there is any original data originally written on the track T1 on the side where the data D2 was written with an overrun, the original data is rewritten to the track T1 as well (S4). With this operation, the original data originally written on the track T1 can be protected from being lost.

The first threshold value (first tolerance value) Q1 for data off-track between the tracks T1 and T2 in pair is less than the second threshold value (second tolerance value) Q2 for data off-track toward the gap G side from the tracks T1 and T2. With this configuration, the reliability of data write and the safety of written data on the tracks T1 and T2 which make a pair can be enhanced.

Further, upon the above-described rewriting of the original data originally written on the track T1 (S4), the controller 30 changes the first threshold value Q1 in the reduction direction by a predetermined value ΔQ in order to reliably protect the rewritten data D2 on the track T2 with even higher safety from the offsetting of the original data rewritten to the track T1.

When the original data originally written on the track T1 is rewritten to the track T1, and further the rewritten original data has overrun by a distance of the new first threshold value “Q1-ΔQ” or more from the track T1 to the track T2 side (NO in S3), the controller 30 determines that the original data is written off-track unnecessarily towards the track T2 side, and then rewrites the same original data to the track T1, and further rewrites the rewritten data D2 already on the track T2 to the track T2 (S4).

The above-provided explanation is made in connection with the example of data write and read for the tracks T1 and T2, but note that the controller 30 performs operations similar to the above for the second pair of tracks T3 and T4, the third pair of tracks T5 and T6, the fourth pair of tracks T7 and T8, the fifth pair of tracks T9 and T10, and the sixth pair of tracks T11 and T12. With this operation, the reliability of data write to each track T in the second to sixth pair of tracks and the safety of the written data can be enhanced.

Suppose that parts of the three tracks T1, T2, and T3 overlap each other, as shown in FIG. 9. In this case, there is a possibility that the data D2 written to the middle track T2 becomes unreadable due to the influence of the data D1 and D3 on the tracks T1 and T3 of the two respective sides. In other words, it becomes impossible to perform random read/write. However, in the configuration of the present embodiment, where two tracks T1 and T2 are adjacent ro each other without a gap G, such a problem does not occur.

Note that in the above-described embodiment, the configuration in which twelve tracks T1 to T12 are present on the magnetic disk 1 is used as an example, but the number of tracks is not limited. In practice, more tracks T may be formed on the magnetic disk 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is

1. A magnetic disk device comprising:
a circular magnetic disk on which a plurality of tracks for recording data are formed in a radial direction; and
a magnetic head which can move in a radial direction of the magnetic disk and perform data write and read on each of the tracks of the magnetic disk,
wherein
the tracks include pairs of two tracks adjacent to each other without a gap, each two being as a pair of tracks, and
there are gaps respectively between these pairs of tracks.

2. The device of claim 1, wherein
the magnetic head includes a write element for data write, which has a width equal to a width of each of the tracks, and a read element for data read, which has a width less than the width of each of the tracks.

3. The device of claim 1, wherein
each pair of tracks includes a part of one track and a part of an other track that overlap each other in the radial direction of the magnetic disk.

4. The device of claim 1, further comprising:
a controller which controls rotation of the magnetic disk, movement of the magnetic head, and write and read of the data by the magnetic head;
wherein
the controller, when the data written to one of the each pair of tracks overruns by a distance of a threshold value or more from the one of the tracks towards the other track side of the pair of tracks, rewrites the data written on the one track to the same one of the tracks, and rewrites the data written to the other track to the same other of the tracks.

5. The device of claim 1, further comprising:
a controller which controls rotation of the magnetic disk, movement of the magnetic head, and write and read of the data by the magnetic head;
wherein
the controller, when the data written to one of each pair of tracks overruns by a distance of a second threshold value from that one track toward a gap side of the one track, rewrites the data written to that one track to the same one track, and
when the data written to one of each pair of tracks overruns by a distance of a first threshold value (<the second threshold) or more from that one track to the other track of the same pair of tracks, rewrites the data written to that one track to the same one track and rewrites the data written to the other track to the same other track.

6. The device of claim 5, wherein
the controller changes the first threshold to a reducing side upon the rewriting.

7. A method of controlling a magnet disk device comprising:
a circular magnetic disk on which a plurality of tracks for recording data are formed in a radial direction; and
a magnetic head which can move in a radial direction of the magnetic disk and perform data write and read on each of the tracks of the magnetic disk;
the tracks including pairs of two tracks adjacent to each other without a gap, each two being as a pair of tracks, and
there being gaps respectively between these pairs of tracks,
the method comprising:
when the data written to one of the each pair of tracks overruns by a distance of a threshold value or more from the one of the tracks towards the other track side of the pair of tracks, rewriting the data written on the one track to the same one of the tracks, and rewriting the data written to the other track to the same other of the tracks.
